(19) United States
(12) Patent Application Publication
(10) Pub. No.: US 2018/0165708 A1
(43) Pub. Date: Jun. 14, 2018

(54) Notification Control based on Location, Activity, and Temporal Prediction

(71) Applicant: Adobe Systems Incorporated, San Jose, CA (US)

(72) Inventors: Payal Bajaj, Stanford University, CA (US); Sanket Vaibhav Mehta, Pune (IN); Tanya Goyal, Mumbai (IN); Kokil Jaidka, Philadelphia, PA (US)

(73) Assignee: Adobe Systems Incorporated, San Jose, CA (US)

(21) Appl. No.: 15/374,561

(22) Filed: Dec. 9, 2016

(51) Int. Cl. G06Q 30/02

(52) U.S. Cl. CPC G06Q 30/0251; G06Q 30/0277

(57) ABSTRACT

Techniques and systems are described to control output of a notification by a marketing system based on a prediction of location, activity, and/or time. In one example, selection of a notification from a plurality of notifications by the notification system is based on a series of activities performed by a user over time at respective locations with respect to an item of digital content. Based on this series of activities, a prediction is made by the notification system as to a likely location, activity, and even time at which a future activity is likely to be performed by the user. This prediction is then used by the notification system as a basis to control which notification is to be output by a computing device of the user.

### BACKGROUND

Notifications, such as in-app messages and push notifications, are used by marketing systems to increase a likelihood of conversion in a digital medium environment. Examples of conversion include interaction of a user with the notification (e.g., a “click-through”) through use of a computing device, purchase of a product or service that pertains to the notification, and so forth.

A user, for instance, may view a push notification as an advertisement relating to a product or service while interacting with a mobile application or other digital content on a mobile phone. If the notification is of interest to the user, the user may select the notification. This interaction may result in navigation to webpages that contain more information about the product or service that is a subject of the advertisement, functionality usable to purchase the product or service, and so forth. Each of these selections thus involves conversion of interaction of the user via the computing device with respective notifications into other interactions with other digital content and/or even purchase of the product or service. Thus, configuration of the notifications in a manner that is likely to be of interest to the users increases the likelihood of conversion of the users regarding the product or service.

Conventional techniques to provide notifications support a limited ability to target users. Conventional push notifications, for instance, may be output during user interaction with a mobile application. However, conventional techniques used to provide push notifications to a user of the mobile application do not employ information that may be used to increase a likelihood of conversion. Rather, conventional techniques typically rely on a brute force approach to achieve as many exposures of the notification to users as possible. Thus, these conventional techniques ignore and do not leverage information that may be used to increase a likelihood of conversion by increasing a likelihood that the notification is of interest to a user.

### SUMMARY

Techniques and systems are described to control output of a notification by a marketing system based on a prediction of location, activity, and/or time. In this way, the notifications have an increased likelihood of being of interest to a user and thus increases a likelihood of conversion by the user. In one example, selection of a notification from a plurality of notifications by the notification system is based on a series of activities performed by a user over time at respective locations with respect to an item of digital content. Based on this series of activities, a prediction is made by the notification system as to a likely location, activity, and even time at which a future activity is likely to be performed by the user. This prediction is then used by the notification system as a basis to control which notification is to be output by a computing device of the user. In this way, the notification system captures a likely future activity, location, and time for the user to deliver a contextually relevant notification to improve the user's experience and thus increase a likelihood of conversion.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures may be indicative of one or more entities and thus reference may be made interchangeably to single or plural forms of the entities in the discussion.

FIG. 1 is an illustration of an environment in an example implementation that is operable to employ notification techniques described herein.

FIG. 2 depicts a system in an example implementation in which operation of a rule generation module of FIG. 1 is shown in greater detail.

FIG. 3 is a flow diagram depicting a procedure in an example implementation in which location and activity based rules are generated that are usable to predict a subsequent location or activity associated with a subsequent user.

FIG. 4 depicts a system in an example implementation in which operation of a prediction module of FIG. 1 is shown in greater detail.

FIG. 5 is a flow diagram depicting a procedure in an example implementation in which location-based and activity-based rules are employed to predict a likely location and/or activity for a subsequent user that is then used by the notification system to control which notification is provided to the subsequent user for output.

FIG. 6 illustrates an example system including various components of an example device that can be implemented as any type of computing device as described and/or utilize with reference to FIGS. 1-5 to implement embodiments of the techniques described herein.

### DETAILED DESCRIPTION

### Overview

With over three times the number of mobile computing devices (e.g., mobile phones and tablets) in the world as there are humans, digital marketing techniques that employ notifications (e.g., push notifications and in-app messages) have grown at an ever-increasing rate. Conventional digital marketing techniques, however, ignore potentially useful information that may be used to increase user interest in the notifications.

In one such example, conventional marketing systems do not leverage the potential of notifications to complement a user's physical movements in a physical environment. Physical movement of the user may be relevant to a marketing system in a variety of ways, such as at occasions at which the user is physically headed towards a retail store, and even when moving within the retail store. This physical movement may provide insight into potential desires of a user and thus may serve as a basis to target notifications, such as to provide notifications offering a discount when the user is located at a competitor's physical store.

Activities performed by the user along with this physical movement may offer additional insight into a configuration of a notification that may be of interest to the user. For example, a user may open a mobile application before heading into a physical store to investigate availability of a particular good or service. Thus, this investigation of availability is indicative of an intent of a user to purchase the good or service, which may then be leveraged to target appropriate notifications to the user to support conversion of the good or service. Consequently, notification targeting may have a significant impact in achieving conversion at these points in time. This is because an activity performed by a user with respect to digital content (e.g., the mobile application) at a location and time may lend insight into an intent of the user at that or another location at a future point in time.

In another example, a user may interact with a mobile application when located at a physical retail store to compare prices of a good or service at a competitor's store. Thus, this activity (e.g., the interaction to compare prices) indicates an intent of the user to purchase a good or server at a lower cost. Based on this, a notification may be targeted by a notification system towards the user when visiting the competitor's store about availability of a discount for the good or service and thus increase a likelihood of conversion.

In a further example, the user may explore a variety of restaurant options in a mobile application. Accordingly, when the user physically enters one of the restaurants, the marketing system may send discount offers based on cuisine preferences of the user by learning what other users that followed a similar journey order from the restaurant, e.g., via the mobile application. This may be extended to lodging (e.g., hotel chains), amusement parks (e.g., for ride and dining suggestions), and so forth.

In yet another example, a user may interact with a mobile application at home and then physically venture to a corresponding retail store and use the application again. This reflects an intent of the user to compare prices. From this, a marketing system may be able to identify patterns indicative of such an intent and cause communication of notifications via the mobile application when the user is “at the right location and at the right time,” e.g., when the user leaves the home immediately after interacting with the application.

Accordingly, techniques and systems are described to control output of a notification by a marketing system based on a prediction of location, activity, and/or time. In one example, selection of a notification from a plurality of notifications by the notification system is based on a series of activities performed by a user over time at respective locations with respect to an item of digital content, e.g., through interaction with a mobile application. Based on this series of activities, a prediction is made by the notification system as to a likely location, activity, and even time at which a future activity is likely to be performed by the user. This prediction is then used by the notification system as a basis to control which notification is to be output by a computing device of the user. In this way, the notification system captures a likely future activity, location, and time for the user to deliver a contextually relevant notification to improve the user's experience and thus increase a likelihood of conversion.

Thus, use of the prediction the notification system may achieve numerous advantages over conventional notification systems. In one such example, the notification system is configured to rank and select notifications by matching content of the notification with a next predicted activity of a user. This enables a marketing system to target notifications to the user based on this activity, such as to help the user to discover digital content of interest in real time when interacting with a mobile application.

In another example, the notification system is configured to rank and select notifications based on a proximity of a predicted location of a user (e.g., a computing device of the user) to a location associated with a notification. In an implementation, the predicated location of the user and the location associated with the notification are semantic locations. Semantic locations involve use of a proper name (e.g., Goodtime Amusement Park) or type (e.g., a point-of-interest type such as amusement park, restaurant, lodging, parking lot, government building, tourist attraction) rather than a non-semantic description of the location, e.g., positional coordinates. In this way, the description of the location as a semantic location may be used to determine similarity of locations that may involve different actual geographic locations. This enables marketing systems to complement a user journey by suggesting relevant activities at near-by locations to where the customer is going in real-time and thus may address a likely context and intent of a user.

The notification system may also address a temporal order in which the users physically move between locations and perform various activities, e.g., through interaction with digital content. This enables a marketing system to predict where the user is going next or what activity will be performed by the user and control output of notifications based on this prediction. In this way, the marketing system may target provision of notifications to a user by taking advantage of considerations that were not possible using conventional techniques, such as time, activity, and/or location as further described in the following.

Example Terms

“Digital content” may take a variety of forms, such as an application (e.g., a mobile application of a mobile phone or tablet), web content (e.g., a webpage viewed through a browser), and so forth.

“Notifications” are output by a computing device. Notification examples include “in-app” notifications, pop-up messages, push notifications, lock-screen notifications, and so forth. Output of a notification may be performed within a context of digital content (e.g., displayed within a user interface of the digital content) or outside a context of the digital content, e.g., on a lock screen, pop up notification, audio alert, and so forth.

“Activities” in the following involve interaction with digital content. An activity, for instance, may involve navigation through the digital content, selection of an item (e.g., a representation, menu item, link) within a user interface, entry of a search query, gestures performed, particular portions of the digital content involved in the activity, and so forth.

A “semantic location” captures semantics associated with a physical location and thus may be used to compare locations having a corresponding semantic class type as an abstraction of positional coordinates, e.g., latitude and longitude. The semantic location, for instance, may describe a name associated with the location (e.g., Pizza Parlor) or a semantic class type (e.g., point-of-interest name) associated with the location, e.g., restaurant, lodging, government building, amusement park, ride at an amusement park, parking lot, gas station, and other point-of-interest type.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

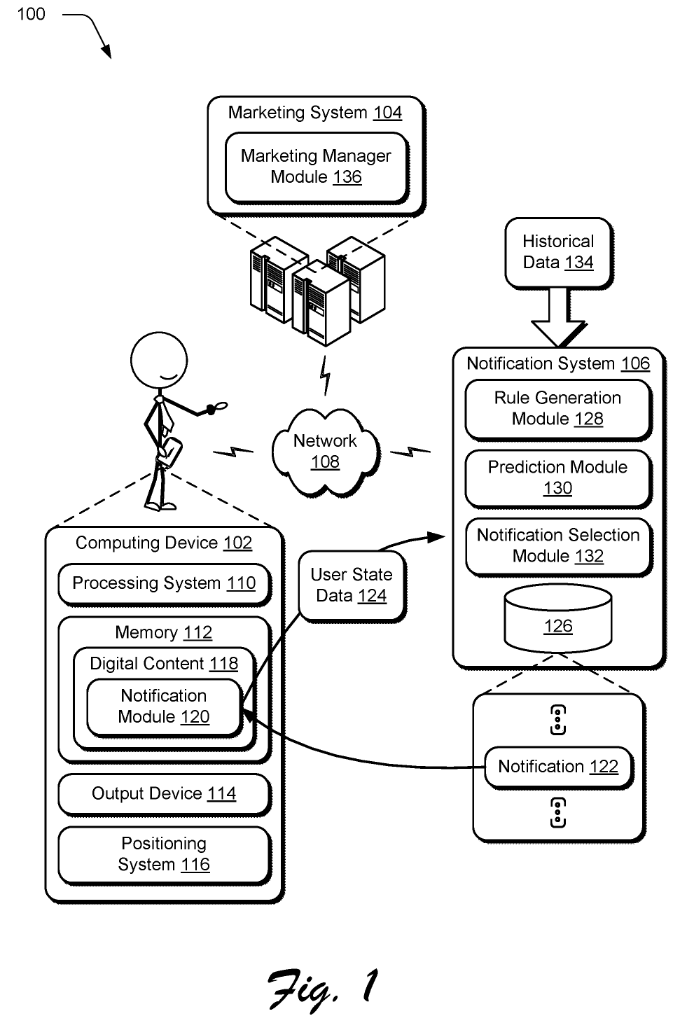

FIG. 1 is an illustration of a digital medium environment 100 in an example implementation that is operable to employ notification and prediction techniques described herein. The illustrated environment 100 includes a computing device 102, a marketing system 104, and a notification system 106 that are communicatively coupled, one to another, via a network 108. The computing device 102, marketing system 104, and the notification system 106 are implemented by one or more computing devices.

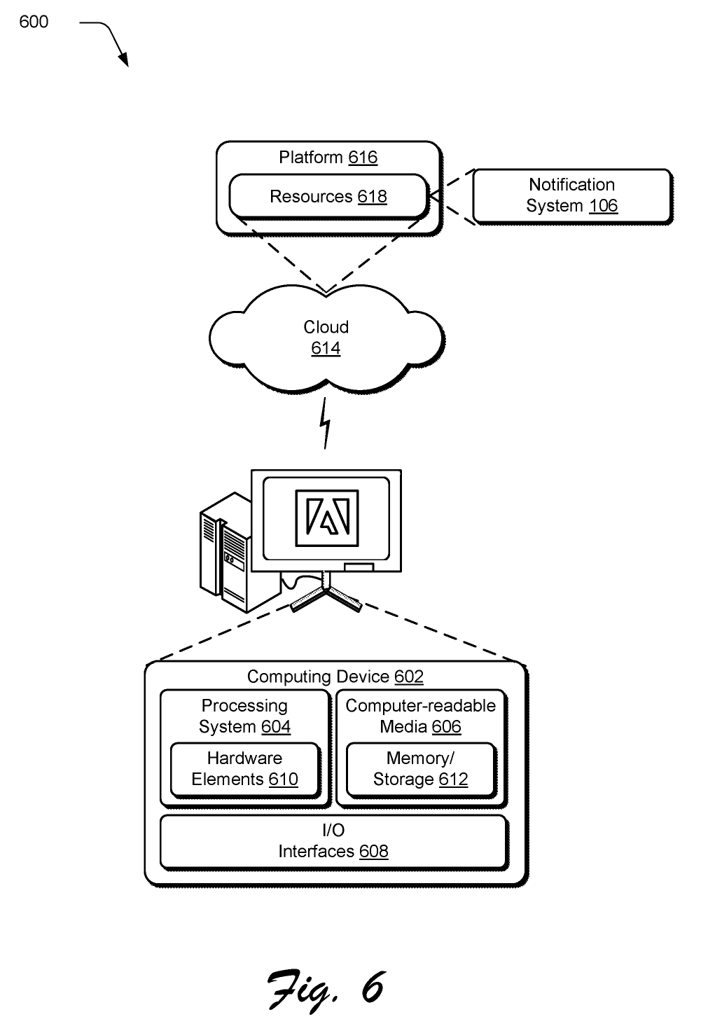

Computing devices may be configured in a variety of ways. A computing device, for instance, may be configured as a desktop computer, a laptop computer, a mobile device (e.g., assuming a handheld configuration such as a tablet or mobile phone), and so forth. Thus, the computing device may range from full resource devices with substantial memory and processor resources (e.g., personal computers, game consoles) to a low-resource device with limited memory and/or processing resources (e.g., mobile devices). Additionally, a computing device may be representative of a plurality of different devices, such as multiple servers utilized by a business to perform operations “over the cloud” as further described in relation to FIG. 6.

The digital medium environment 100 is configured to control output of notifications by the computing device 102 based on a prediction that takes into account temporal, location, and/or activity considerations. The computing device 102, for instance, includes a processing system 110 and an example of a computer-readable storage medium illustrated as a memory 112. The computing device 102 also includes an output device 114 (e.g., display device, audio output device) and a positioning system 116 configured to determine a location at which the computing device 102 is disposed, e.g., a GPS system.

Digital content 118 is illustrated as being stored in the memory 112 and is executable by the processing system 110. The digital content 118 may take a variety of forms, such as an application (e.g., a mobile application), browser via which other digital content such as webpages may be obtained, operating system, and so forth. The digital content 118 also includes a notification module 120 that is configured to output a notification 122 via the output device 114. Notification 122 examples include “in-app” notifications, pop-up messages, push notifications, lock-screen notifications, and so forth.

The notification module 120, for instance, may generate user state data 124 that describes previous and current user states regarding interaction with the digital content 118 that are used to form the predictions. The user state data 124, for instance, may describe a series of activities performed by the user with respect to digital content 118 and a time and location at which a respective activity of the series of activities is performed. In one example, the notification module 120 monitors user activities (e.g., navigation within an application, particular operations initiated, user inputs provided, links selected, and so forth) and obtains a corresponding location and time from the positioning system 116 at which the activity is performed. Other examples are also contemplated, such as to utilize an internal clock of the computing device 102.

This user state data 124 is then provided via the network 108 to the notification system 106 such that the notification system 106 may control which of the notifications 122 are provided to the computing device 102 for output by the output device 114. Output of the notification 122 may be performed within a context of the digital content 118 (e.g., displayed within a user interface of the digital content 118) or outside a context of the digital content 118, e.g., on a lock screen, pop up notification, audio alert, and so forth.

In order to select the notification 122, which is illustrated as stored in storage 126, the notification system 106 employs a rule generation module 128, a prediction module 130, and a notification selection module 132. The rule generation module 128 is implemented at least partially in hardware to generate location and activity based rules as a model of user activities and locations at times at which those activities occurred based on historical data 134.

These rules are then used by a prediction module 130 to predict a likely activity, location and/or time at which the activity or location is to be performed or reach by a user by processing the user state data 124 based on these rules. This prediction of location, activity, or time from the prediction module 130 is then employed by a notification selection module 132 to select at least one notification from a plurality of notifications 122 maintained in storage for output by the computing device 102 of the user that is described by the user state data 124. In this way, a marketer, through interaction with a marketing manager module 136 of the marketing system 104, may configure notifications 122 to take this prediction into account, thereby improving a likelihood of conversion. The marketer, for instance, may configure notifications based on a predicted location, a predicted activity, or both. This technique may be divided into two parts, rule generation as a model of user interaction with digital content and rule selection to make a temporal, location, and/or activity prediction, each of which are described in corresponding sections in the following.

Rule Generation as a Model of User Interaction with Digital Content

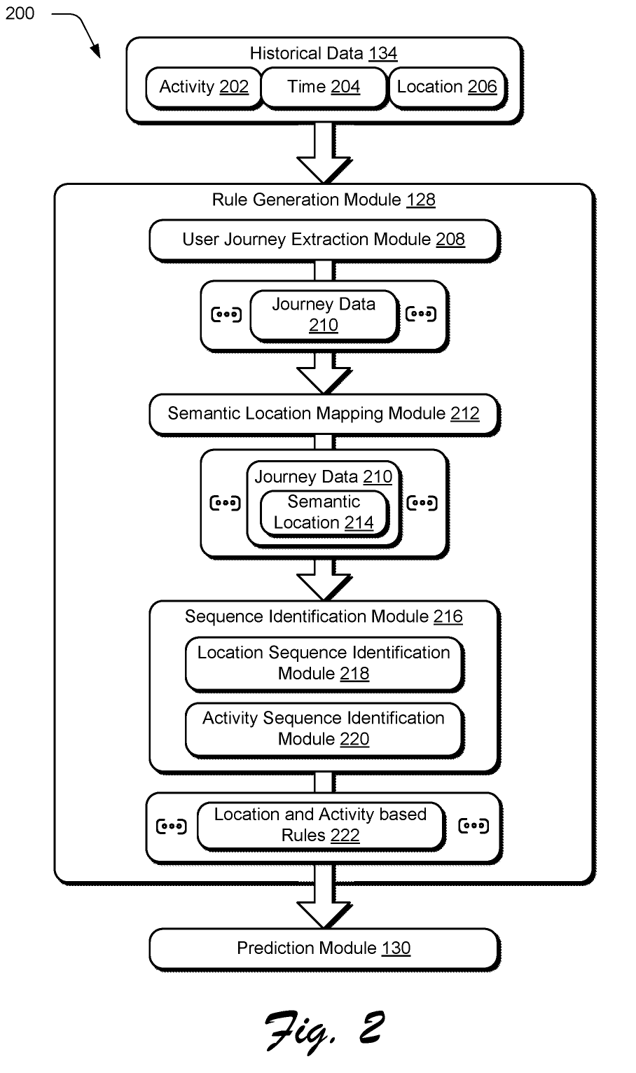

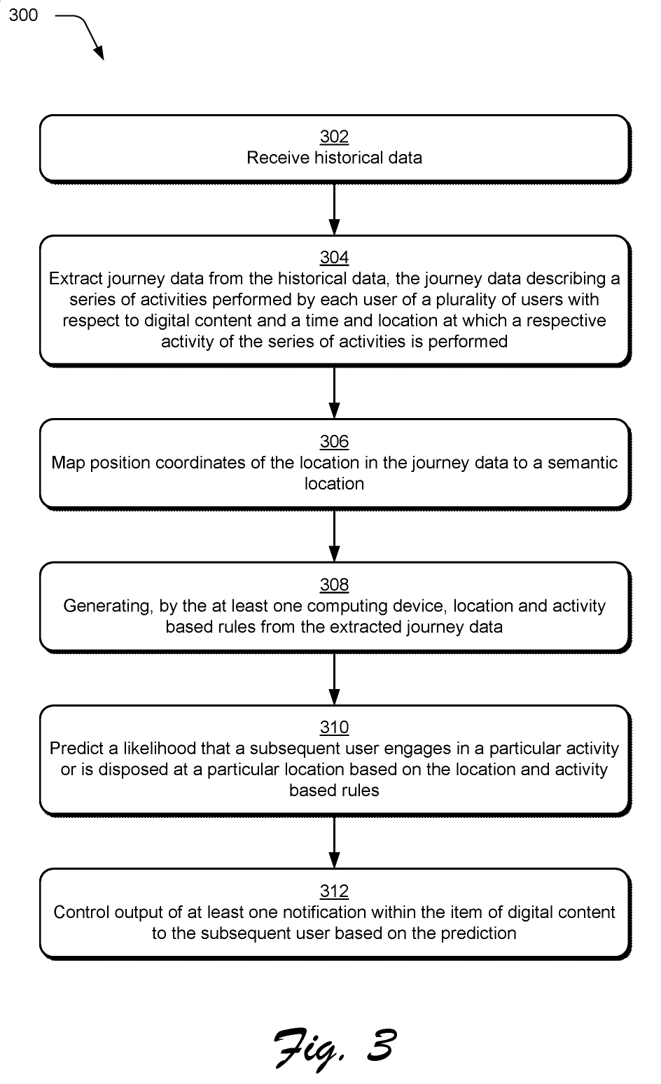

FIG. 2 depicts a system 200 in an example implementation in which operation of a rule generation module 128 of FIG. 1 is shown in greater detail. FIG. 3 depicts a procedure 300 in an example implementation in which location-based and activity-based rules are generated that are usable to predict a subsequent location or activity associated with a subsequent user.

The following discussion describes techniques that may be implemented utilizing the described systems and devices. Aspects of each the procedure may be implemented in hardware, firmware, software, or a combination thereof. The procedure is shown as a set of blocks that specify operations performed by one or more devices and are not necessarily limited to the orders shown for performing the operations by the respective blocks. In portions of the following discussion, reference will be made interchangeable to FIGS. 2 and 3.

To begin, historical data is received (block 302). The historical data 134 may be collected from a variety of different sources, such as from an analytics service, a web service, and so forth. The historical data 134 describes activities 202 involving user interaction with digital content 118 as well as a time 204 and location 206 at which those activities 202 occurred. Digital content 118, as previously described, may take a variety of forms, such as an application (e.g., a mobile application of a mobile phone or tablet), web content (e.g., a webpage viewed through a browser), and so forth. Accordingly, activities 202 may also take a variety of forms. An activity 202, for instance, may involve navigation through the digital content, selection of an item (e.g., a representation, menu item, link) within a user interface, entry of a search query, gestures performed, particular portions of the digital content involved in the activity, and so forth.

Each activity 202 included in the historical data 134 is associated with a time 204 and location 206 at which the activity occurred. A computing device 102, for instance, may associate a timestamp from an internal clock or positioning system 116 with each activity 202 as performed. The positioning system 116 may also associate a location 206 as a set of positional coordinates, e.g., longitude and latitude from a global positioning system. In another example, the time 204 is relative and thus usable to indicate an order, in which, the activities 202 occurred but not a particular point-in-time at which the activity 202 occurred. In a further example, the time 204 is inferred when not available, e.g., by querying a news feed of a social network service associated with the user to determine when and/or where the user is located.

After receipt of the historical data 134, a user journey extraction module 208 is utilized to extract journey data 210 from the historical data 124. The journey data 210 describes a series of activities 202 performed by each user of a plurality of users with respect to digital content. The journey data 210 also describes a time 204 and location 206 at which a respective activity of the series of activities is performed (block 304). The user journey extraction module 208, for instance, may extract a journey as a temporal series of activities that correspond to an individual user and a time and location at which these activities occur. Thus, each series of activities describes a journey of the user involving interaction with digital content at a corresponding location and time. In this way, the journey data 210 describes a journey involving activities and variations in location by a user in performing those activities over time.

A user, for instance, may search for a dining place around lunch time through interaction with digital content (e.g., a mobile application) as well as physically travel proximal to a restaurant. At a later point in time (e.g., that evening), the user may then search an online bookstore while at a physical shopping center. The journey data 210, extracted from the historical data 134 by the user journey extraction module 208, may thus describe this user's journey over time (e.g., throughout the day) and activities involved at corresponding parts of the journey.

This journey data 120 may then serve as a basis to analyze what activities are performed by users at different locations, and how this behavior changes with time as a basis to predict activities and locations of subsequent users. In the following discussion, the user journey has the following mathematical form:

{tᵢ_{₁}:(lᵢ_{₁},aᵢ_{₁}),tᵢ_{₁}:(lᵢ_{₂},aᵢ_{₂}), . . . ,tᵢ_{ₙ}:(lᵢ_{ₙ},aᵢ_{ₙ})},

where “lᵢ_{ₖ}” denotes the location, “aᵢ_{ₖ}” denotes the activity at location “lᵢ_{ₖ}” and “tᵢ_{₁}≤tᵢ_{₂}≤ . . . ≤tᵢ_{ₙ}” are successive points in time that together are described as a location-activity journey of a respective user within the historical data 134. The journey data 210 is thus generated by the user journey extraction module 208 for each user of a plurality of users described in the historical data 134, e.g., for those users that exhibit a series of activities.

In an implementation, position coordinates of the location 206 in the journey data are mapped to semantic locations (block 306). In one example, locations 206 in the historical data 134 are described using positional coordinates, e.g., latitude and longitude from a GPS or other positioning system 116. Thus, these positional coordinates describe a physical location, solely, and nothing else about the location 206. Accordingly, the semantic location mapping module 212 may be employed to map the location 206 into a semantic location 214. The semantic location 214 captures semantics associated with the location and thus may be used to compare locations 206 having a corresponding semantic class type as an abstraction of the coordinates.

The semantic location 214, for instance, may describe a name associated with the location (e.g., Pizza Parlor) or a semantic class type (e.g., point-of-interest name) associated with the location, e.g., restaurant, lodging, government building, amusement park, ride at an amusement park, parking lot, gas station, and other point-of-interest type. The semantic location 214 may be mapped in a variety of ways by the semantic location mapping module 212, such as to access an application programming interface of a web service, e.g., a Google® Maps Geocoding API. For instance, a latitude-longitude pair “28.4205968, −81.5813053” translates to “Fantasyland®”, whereas “28.4190575, −81.5791225” translates to “Tomorrowland®,” both at the “Magic Kingdom Park®, Florida” at Disneyworld®. Thus, these semantic locations provide a rich description of the locations which may expand an ability to describe a user's journey as well as predict journeys of subsequent users.

Semantic locations 214 may be used to expand an ability to compare locations, one to another, as well as expand an ability to determine “what” is at the particular location. As such, the semantic location 214 may provide additional insight as to the surroundings at which the activity 202 occurred rather than just merely the coordinates of where the activity 202 occurred as described above. The semantic location 214 may also support comparison with other semantic locations, even though those locations may correspond with different actual geographic locations. In one such example, users may journey through different geographic locations but progress through the same or similar semantic locations, such as different geographic locations at similar points in time having similar types of restaurants. In this way, these different actual geographic locations may be used to support predictions having greater accuracy as described in greater detail in the following by describing “what” is at the respective locations. Consequently, semantic locations may be used to expand an ability of the notification system 106 to determine a likely user's intent based on a journey through the semantic locations 214, which is not possible through use of positional coordinates, alone.

The journey data 210, having the semantic locations 214 in this example, is then received by a sequence identification module 216. The sequence identification module 216 is implemented at least partially in hardware of a computing device to mine frequent location/activity patterns from the journey data 210. Functionality to do so is represented in the system 200 of FIG. 2 by a location sequence identification module 218 and an activity sequence identification module 220. The location sequence identification module 218 and the activity sequence identification module 220 are configured to jointly generate location and activity based rules 222 from the extracted journey data 210 (block 308). The location and activity based rules 222 model a sequence in which users move from one location to another and a sequence in which the users perform activities at these locations, respectively. As such, these rules may be used to predict activities and locations of a subsequent user as further described below.

The sequence identification module 216, for instance, may determine a frequency at which users engage in a series of activities and corresponding locations based on frequency of those occurrences exhibited in the journey data 210. From this, the location and activity based rules 222 are generated to reflect this frequency based on corresponding journeys used to reach those activities and locations based on the historical data 134.

These rules are then provided to a prediction module 130 and used to predict a likelihood that a subsequent user engages in a particular activity and/or is disposed at a particular location (block 310). The predicted location and/or activity is then used as a basis to control output of at least one notification within the item of digital content to the subsequent user (block 312). The prediction module 130, for instance, may obtain data that describes a series of activities and locations and times at which those activities occurred for a subsequent user. The location and activity based rules 222 are then used to predict a next likely activity and/or location for the subsequent user based on similar series exhibited by the historical data 134. This prediction is used as a basis by the notification system 106 to control which notification is provided for output to the subsequent user. In this way, the prediction may increase a likelihood that the notification is of interest to the user and result in subsequent conversion by the user. Further discussion of this example is included in the following section and shown using corresponding figures.

Prediction and Notification Control

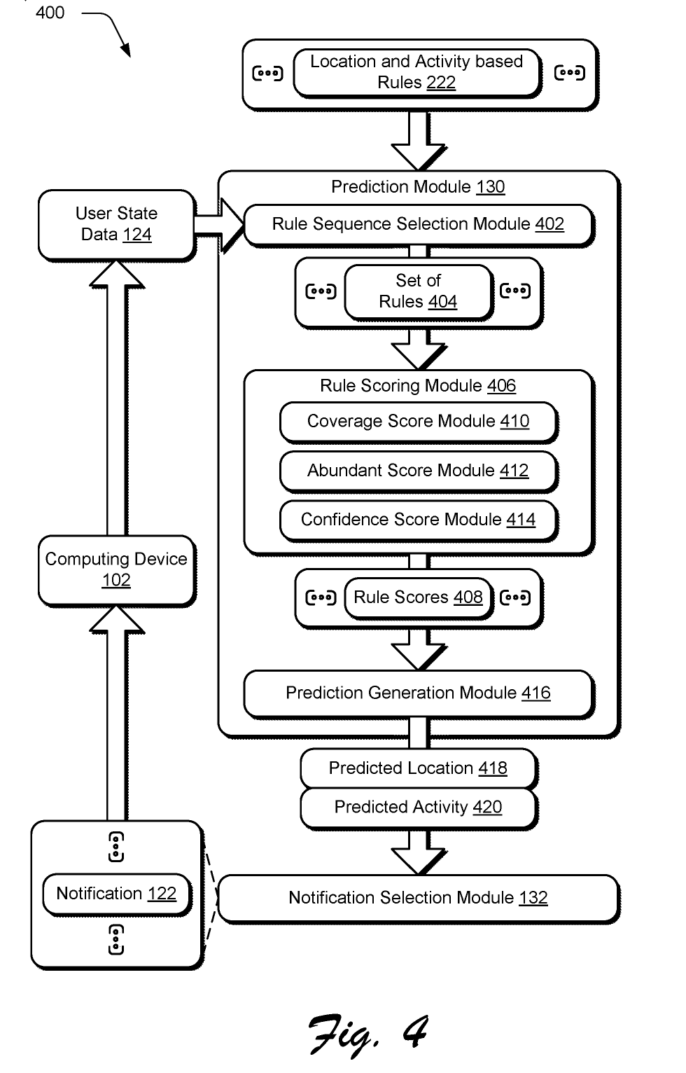

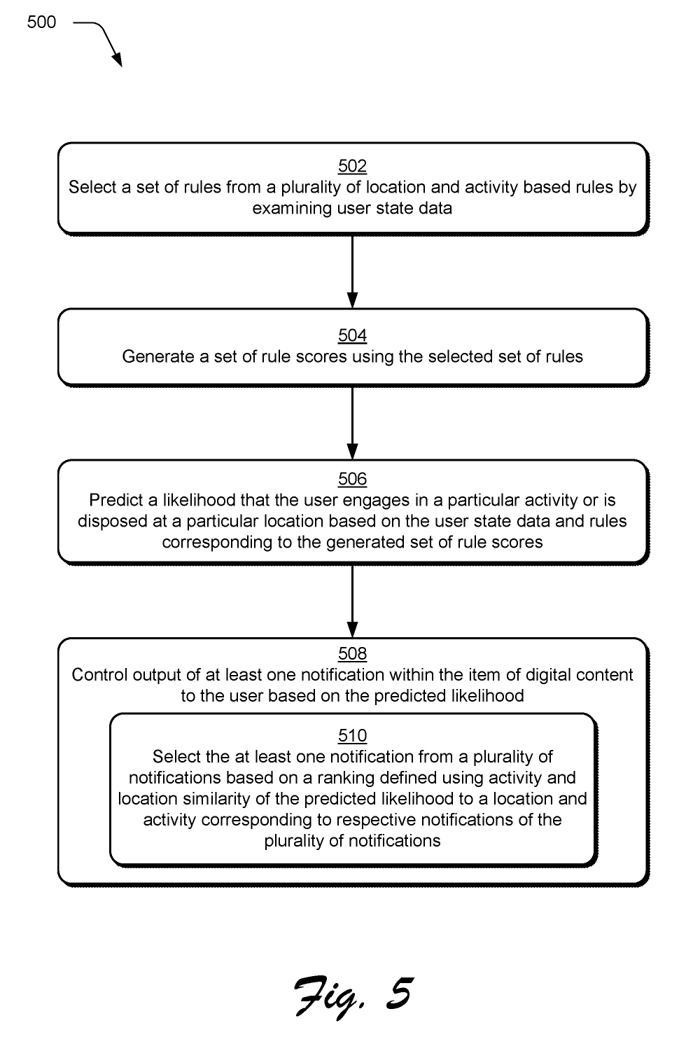

FIG. 4 depicts a system 400 in an example implementation in which operation of the prediction module 130 of FIG. 1 is shown in greater detail. FIG. 5 depicts a procedure 500 in an example implementation in which location and activity based rules are employed to predict a likely location and/or activity for a subsequent user that is then used by the notification system 106 to control which notification is provided to the subsequent user for output.

The following discussion describes techniques that may be implemented utilizing the described systems and devices. Aspects of each the procedure may be implemented in hardware, firmware, software, or a combination thereof. The procedure is shown as a set of blocks that specify operations performed by one or more devices and are not necessarily limited to the orders shown for performing the operations by the respective blocks. In portions of the following discussion, reference will be made interchangeable to FIGS. 4 and 5.

To begin, the prediction module 130 receives the location and activity based rules 222 of FIG. 2. User state data 124 is also received. The user state data describes a series of activities performed by a user with respect to digital content along with a time and location at which a respective activity of the series of activities is performed. For example, the user state data 124 may be configured as a temporal order of location/activity pairs observed for a corresponding user regarding interaction with the digital content 118.

A rule sequence selection module 402 is then employed to select a set of rules 404 from the plurality of location and activity based rules 222 by examining the user state data 124 (block 502). The rules include two parts. The first part is referred to as an antecedent and is expressed mathematically as follows:

{(l₁,a₁),(l₂,a₂),(lₖ₋₁,aₖ₋₁)}”

The second part is referred to as a consequent and is expressed mathematically as follows:

{(lₖ,aₖ)}

Thus, the location and activity based rules 222 have the form of “antecedent→consequent.” Both the antecedent and consequent correspond location-activity journeys of a subsequent user that is a subject of the prediction, e.g., a series of activities having corresponding locations and times at which the activities were performed.

The rule sequence selection module 402 is implemented at least partially in hardware of a computing device to identify which of the location and activity based rules 222 are to be used for prediction. To do so, the rule sequence selection module 404 compares the antecedent of a respective one of the plurality of rules to the current state of the user as described in the user state data 124. In an implementation, if the user state data 124 contains information about past “n” time units, the rule sequence selection module 404 examines the location-based or activity-based rules 222, 224 with antecedents of size “n” or less.

For a given state of the user as described in the user state data 124 for “n” time slots “{u₁, u₂, . . . , uₙ},” the location and activity-based rules 222 are examined by the rule sequence selection module 404 with antecedents of the form “{r₁, r₂, . . . , rₘ},” where “uᵢ” and “rⱼ” are of the form “{(lᵢ_{₁}, aᵢ_{₁}), (lᵢ_{₂}, aᵢ_{₂}),}” such that “m<=n,” and “r₁ ∩uᵢ_{₁}≠Ø” and “r₂ ∩uᵢ_{₂}≠Ø” and so on until “rₘ∩uᵢ_{ₘ}≠Ø” for “1<i₁<i₂< . . . <iₘ<=n.” In other words, if all the parts of antecedent of the rule match the states of the user in sequence as defined by the user state data 124, the prefix of the rule is selected by the rule sequence selection module 402 for inclusion in the set of rules 404. The consequent of the rule is used for location-activity prediction by the prediction generation module 416 as further described below.

A rule scoring module 406 is then employed to generate a set of rule scores 408 using the selected set of rules 404 (block 504). The set of rule scores 408 are used by the rule scoring module 406 to rank the set of rules 404 based on which respective antecedent matches the given state of the user as described in the user state data 124. For each matching rule “r” of the form “{r₁, r₂, . . . , rₘ},” for instance, the rule scoring module 406 matches the given state of the user from the user state data 124 as “r₁ ∩uᵢ_{₁}≠Ø” and “r₂ n uᵢ_{₂}≠Ø” and so on till “rₘ∩uᵢ_{ₘ}≠Ø” for “1<i₁<i₂< . . . <iₘ<=n” as follows. The set of rule scores 408 may be generated based on a variety of scores, examples of which include generation of a coverage score by a coverage score module 410, an abundant score by an abundant score module 412, and a confidence score by a confidence score module 414.

In order to generate the coverage score, the coverage score module 410 calculates the following:

$$coverageScore = \frac{\vert {r}_{1} ⋂ {u}_{i 1} \vert + \vert {r}_{2} ⋂ {u}_{i 2} \vert + … + \vert {r}_{m} ⋂ {u}_{im} \vert}{\vert {u}_{i 1} \vert + \vert {u}_{i 2} \vert + … + \vert {u}_{im} \vert}$$

The coverage score quantifies how much of the user's given state as described in the user state data 124 is observed in the selected rule from the set of rules 404. The coverage score is normalized by the amount of information known about the user.

In order to generate the abundant score, the abundant score module 412 calculates the following:

$$abundantScore = \frac{\vert {r}_{1} - {u}_{i 1} \vert + \vert {r}_{2} - {u}_{i 2} \vert + … + \vert {r}_{m} - {u}_{im} \vert}{\vert {r}_{1} \vert + \vert {r}_{2} \vert + … + \vert {r}_{m} \vert}$$

The abundant score quantifies how much extra information is included in the selected rule from the set of rules 404 in comparison with the user's given state as described in the user state data 124. The abundant score is normalized by the amount of information in the antecedent of the rule.

The confidence score denotes the probability of consequent if the antecedent is observed in the dataset, i.e., the user state data 124. In order to generate the confidence score, the confidence score module 414 calculates the following:

$$Confidence ( r \text{:} \{ ( {l}_{1} , {a}_{1} ) , ( {l}_{2} , {a}_{2} ) , … , ( {l}_{k - 1} , {a}_{k - 1} ) \} -> \{ ( {l}_{k} , {a}_{k} ) \} = \frac{Support ( \{ ( {l}_{1} , {a}_{1} ) , ( {l}_{2} , {a}_{2} ) , … , ( {l}_{k - 1} , {a}_{k - 1} ) , , ( {l}_{k} , {a}_{k} ) \} )}{Support ( \{ ( {l}_{1} , {a}_{1} ) , ( {l}_{2} , {a}_{2} ) , … , ( {l}_{k - 1} , {a}_{k - 1} ) \} )}$$

where “Support” is the number of times that sequence has been observed in the data.

From these scores, the rule scoring module 408 in this example then computes a final rule score 408 of respective rules of the set of rules 404 as follows:

rule score=(coverageScore−abundantScore+confidenceScore)/3.

A variety of other rule examples are also contemplated.

A prediction generation module 418 is then employed to predict a likelihood that the user engages in a particular activity or is disposed at a particular location based on the user state data 410 and rules corresponding to the generated set of rule scores 410 (block 506). The prediction generation module 416, for instance, may select a subset of the set of rules 404 (e.g., the top ten) based on the rule scores 408. The prediction generation module 416 then uses the consequent of these rules to generate the predicted location 418 and/or predicted activity 420 of a user that corresponds to the user state data 124.

A notification selection module 132 is then leveraged to control output of at least one notification to the user based on the predicted likelihood (block 508), e.g., the predicted location 420 and/or the predicted activity 422. A marketing system 104, for instance, may configure notifications for output based solely on a predicted location 420 of the user based on the user state data 124. Thus, in this example the location is used to determine which notification 122 for output. In another example, the marketing system 104 may configure notification for output based solely on a predicted activity for the user based on the user state data 124.

The notification selection module 132 may also be employed to select a notification 122 from a plurality of notifications based on a ranking defined using both the predicted location 418 and the predicted activity 420. The notification selection module 132, for instance, may select the notification 122 based on activity and location similarity of the predicted likelihood to a location and activity corresponding to respective notifications of the plurality of notifications (block 510). This prediction of activities and locations of interest is usable to infer an intent of the subsequent user. This provides the marketing system 104 with insights into what should be included within the notification 122 in order to increase a likelihood of conversion.

The marketing system 104, for instance, may provide a collection of pre-defined notifications 122 to be sent out to users of digital content 118, e.g., a mobile application. The notification may be associated with certain locations of interest. The predicted locations and activities 418, 420 are then used by the notification selection module 132 to rank these notifications.

Let “M” represent the repository of messages (i.e., which correspond to notifications 122 in the following). Every message “m” in “M” is associated with location “mₗ” and has content “m_{c}.” For a user with predicted state “<l,a>,” a function “ƒ(<l,a>, m)” is used by the notification selection module 132 to create a ranked list of messages “Mᵤ” for the subsequent user. The function f is defined as follows:

ƒ(<l,a>,m)=α*ƒₗ(l,mₗ)+(1−α)*ƒₐ(a,m_{c})

ƒₗ(l,mₗ)=proximity(l,mₗ)

ƒₐ(a,m_{c})=content similarity(a,m_{c})

Proximity is a function of how a distance between “l” and a location associated with “mₗ” and content similarity is a function which measures an association between activity “a” and the content of the message “m_{c}.” The parameter “α” controls the relative importance of predicted location and activity in ranking the messages.

These ranked messages are then used by the notification selection module 132 to complement a journey of the subsequent user in real time. When a location and activity of the subsequent user changes, the messages are updated by the notification selection module 132 to send most relevant messages at the right time. In a real world implementation, activities of the users at a particular location was predicted by the notification system 106 with a precision of approximately 75%. In this way, the notification system 106 may generate accurate predictions of location, activity, and time which are used as an accurate basis to target notifications 122 based on these predictions.

Example System and Device

FIG. 6 illustrates an example system generally at 600 that includes an example computing device 602 that is representative of one or more computing systems and/or devices that may implement the various techniques described herein. This is illustrated through inclusion of the notification system 106. The computing device 602 may be, for example, a server of a service provider, a device associated with a client (e.g., a client device), an on-chip system, and/or any other suitable computing device or computing system.

The example computing device 602 as illustrated includes a processing system 604, one or more computer-readable media 606, and one or more I/O interface 608 that are communicatively coupled, one to another. Although not shown, the computing device 602 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of functionality to perform one or more operations using hardware. Accordingly, the processing system 604 is illustrated as including hardware element 610 that may be configured as processors, functional blocks, and so forth. This may include implementation in hardware as an application specific integrated circuit or other logic device formed using one or more semiconductors. The hardware elements 610 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 606 is illustrated as including memory/storage 612. The memory/storage 612 represents memory/storage capacity associated with one or more computer-readable media. The memory/storage component 612 may include volatile media (such as random access memory (RAM)) and/or nonvolatile media (such as read only memory (ROM), Flash memory, optical disks, magnetic disks, and so forth). The memory/storage component 612 may include fixed media (e.g., RAM, ROM, a fixed hard drive, and so on) as well as removable media (e.g., Flash memory, a removable hard drive, an optical disc, and so forth). The computer-readable media 606 may be configured in a variety of other ways as further described below.

Input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 602 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 602. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 602, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 610 and computer-readable media 606 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 610. The computing device 602 may be configured to implement particular instructions and/or functions corresponding to the software and/or hardware modules. Accordingly, implementation of a module that is executable by the computing device 602 as software may be achieved at least partially in hardware, e.g., through use of computer-readable storage media and/or hardware elements 610 of the processing system 604. The instructions and/or functions may be executable/operable by one or more articles of manufacture (for example, one or more computing devices 602 and/or processing systems 604) to implement techniques, modules, and examples described herein.

The techniques described herein may be supported by various configurations of the computing device 602 and are not limited to the specific examples of the techniques described herein. This functionality may also be implemented all or in part through use of a distributed system, such as over a “cloud” 614 via a platform 616 as described below.

The cloud 614 includes and/or is representative of a platform 616 for resources 618. The platform 616 abstracts underlying functionality of hardware (e.g., servers) and software resources of the cloud 614. The resources 618 may include applications and/or data that can be utilized while computer processing is executed on servers that are remote from the computing device 602. Resources 618 can also include services provided over the Internet and/or through a subscriber network, such as a cellular or Wi-Fi network.

The platform 616 may abstract resources and functions to connect the computing device 602 with other computing devices. The platform 616 may also serve to abstract scaling of resources to provide a corresponding level of scale to encountered demand for the resources 618 that are implemented via the platform 616. Accordingly, in an interconnected device embodiment, implementation of functionality described herein may be distributed throughout the system 600. For example, the functionality may be implemented in part on the computing device 602 as well as via the platform 616 that abstracts the functionality of the cloud 614.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium environment to control notification output by at least one computing device, a method comprising:
extracting, by the at least one computing device, journey data from historical data, the journey data describing:
a series of activities performed by each user of a plurality of users with respect to digital content; and
a time and location at which a respective activity of the series of activities is performed;
generating, by the at least one computing device, location and activity based rules from the extracted journey data;
predicting, by the at least one computing device, a likelihood that a subsequent user engages in a particular said activity or is disposed at a particular said location based on the location and activity based rules; and
controlling, by the at least one computing device, output of at least one notification within the item of digital content to the subsequent user based on the predicting.

2. The method as described in claim 1, wherein the predicting includes predicting the likelihood that the subsequent user engages in the particular said activity and is disposed at the particular said location.

3. The method as described in claim 2, wherein the predicting includes predicting the likelihood that the subsequent user engages in the particular said activity and is disposed at the particular said location at a particular time.

4. The method as described in claim 1, further comprising mapping position coordinates of the location in the journey data to a semantic location and wherein the generating, the predicting, and the controlling are based on the semantic location.

5. The method as described in claim 4, where the semantic location is expressed as a name associated with the location or a semantic class type associated with the location.

6. The method as described in claim 1, wherein the generating is based on frequency of patterns of the time, the location, and the series of activities exhibited by the journey data.

7. The method as described in claim 1, wherein the generating is based on a temporal order of activities in the series of activities.

8. The method as described in claim 1, wherein the item of digital content is a mobile application and the at least one notification is digital marketing content configured as an in-app message or a push notification.

9. The system as described in claim 1, wherein the controlling includes selecting the at least one notification from a plurality of notifications based on a ranking defined using activity and location similarity of the predicted likelihood to a location and activity corresponding to respective notifications of the plurality of notifications.

10. In a digital medium environment to control notification output by at least one computing device, a system comprising:
a rule sequence selection module implemented at least partially in hardware of the computing device to select a set of rules from a plurality of location and activity based rules by examining user state data, the user state data describing:
a series of activities performed by a user with respect to digital content; and
a time and location at which a respective activity of the series of activities is performed;
a rule scoring module implemented at least partially in hardware of the computing device to generate a set of rule scores using the selected set of rules;
a prediction generation module implemented at least partially in hardware of the computing device to predict a likelihood that the user engages in a particular said activity or is disposed at a particular said location based on the user state data and rules corresponding to the generated set of rule scores; and
a notification selection module implemented at least partially in hardware of the computing device to control output of at least one notification within the item of digital content to the user based on the predicted likelihood.

11. The system as described in claim 10, wherein each rule score of the set of rule scores includes a coverage score, an abundant score, or a confidence score for a respective said selected rule.

12. The system as described in claim 10, wherein the prediction generation module is configured to predict the likelihood that the subsequent user engages in the particular said activity and is disposed at the particular said location.

13. The system as described in claim 12, wherein the prediction generation module is configured to predict the likelihood that the subsequent user engages in the particular said activity and is disposed at the particular said location at a particular time.

14. The system as described in claim 10, further comprising a semantic location mapping module implemented at least partially in hardware of the computing device to map position coordinates of the location in the journey data to a semantic location and wherein the prediction generation module and the notification selection module are configured to use the semantic location.

15. The system as described in claim 10, further comprising:
a user journey extraction module implemented at least partially in hardware of the computing device to extract journey data from historical data, the journey data describing a series of activities performed by each user of a plurality of users with respect to digital content, and a time and location at which a respective activity of the series of activities is performed; and
a sequence identification module implemented at least partially in hardware to generate the location-based rules and activity-based rules based on the extracted journey data.

16. The system as described in claim 15, wherein the sequence identification module is configured to generate the location and activity based rules based on a frequency of patterns of the time, the location, and the series of activities exhibited by the journey data.

17. The system as described in claim 15, wherein the sequence identification module is configured to generate the location and activity based rules based on a temporal order of activities in the series of activities.

18. The system as described in claim 10, wherein the notification selection module is configured to select the at least one notification from a plurality of notifications based on a ranking defined using activity and location similarity of the predicted likelihood to a location and activity corresponding to respective notifications of the plurality of notifications.

19. In a digital medium environment to control notification output by at least one computing device, a system comprising:
means for extracting journey data from historical data, the journey data describing:
a series of activities performed by each user of a plurality of users with respect to digital content; and
a time and location at which a respective activity of the series of activities is performed;
means for generating location and activity based rules based on the extracted journey data;
means for predicting a likelihood that a subsequent user engages in a particular said activity or is disposed at a particular said location based on the location and activity based rules; and
means for controlling output of at least one notification within the item of digital content to the subsequent user based on the predicting.

20. The system as described in claim 19, further comprising means for mapping position coordinates of the location in the journey data to a semantic location and wherein the generating means, the predicting means, and the controlling means utilize the semantic location.
